(19) United States
(12) Patent Application Publication
(10) Pub. No.: US 2025/0133640 A1
(43) Pub. Date: Apr. 24, 2025

(54) LIGHTING APPARATUS

(71) Applicant: LEEDARSON LIGHTING CO.,LTD., Zhangzhou, Fujian (CN)

(72) Inventors: Zhiqing Chen, Zhangzhou (CN); Shihai Huang, Zhangzhou (CN); Hongkui Jiang, Zhangzhou (CN)

(21) Appl. No.: 18/925,033

(22) Filed: Oct. 24, 2024

(30) Foreign Application Priority Data
Oct. 24, 2023 (CN) 202322860894.9

(51) Int. Cl. H05B 45/3725; H05B 45/345; H05B 47/195

(52) U.S. Cl. CPC H05B 45/3725; H05B 45/345; H05B 47/195

(57) ABSTRACT

A lighting apparatus includes an LED driving circuit, an impedance switching circuit and a detection circuit. The lighting apparatus is coupled to a wall switch for connecting to a main power. The LED driving circuit is coupled to the wall switch and an LED lamp. The LED driving circuit includes a sampling terminal. The LED driving circuit is configured to output different driving currents to the LED lamp and perform constant current driving of the LED lamp based on different sampling resistances connected to the sampling terminal. The impedance switching circuit is coupled to the sampling terminal of the LED driving circuit. The impedance switching circuit is configured to output sampling resistances of different impedances to the sampling terminal of the LED driving circuit in response to different impedance switching signals.

### FIELD

The present invention is related to a lighting apparatus, and more particularly related to a lighting apparatus with a flexible control.

### BACKGROUND

Wall switch control has been a fundamental part of light device design for many years. It is widely used across homes, offices, and various facilities to control lighting, providing a simple and effective solution for managing light sources. Over time, numerous types of wall switches have been introduced, each offering distinct functionalities. While these advancements have improved the user experience, they also complicate the design of light devices, as manufacturers must ensure compatibility with different types of switches.

With the growing popularity of LED technology, the light device industry has experienced a significant shift. LED modules have become the standard in modern lighting due to their efficiency and long lifespan. However, this shift presents a challenge in adapting these advanced light sources to traditional manual switches. Many existing wall switches are not optimized for LED modules, leading to potential issues in performance and reliability. These issues are further compounded by the need to accommodate both older, legacy switches and newer, innovative control systems.

Cost remains a critical concern in light device design, particularly when it comes to integrating various switch control systems. As the market moves toward more advanced lighting solutions, maintaining affordability becomes increasingly difficult. Manufacturers must balance the need for innovative control options with the desire to keep costs manageable for consumers. This cost challenge becomes more pronounced as the complexity of light device designs increases with the integration of various types of wall switches and LED modules.

In response to these challenges, developing innovative light device control systems has become essential. A forward-thinking approach is needed to create control solutions that are versatile enough to work with both traditional and modern switch designs. This ensures that new lighting systems remain compatible with existing infrastructure while also preparing for future advancements. An innovative control system would simplify the user experience, enhance the functionality of light devices, and reduce the overall cost of implementation.

Furthermore, the demand for smart home integration continues to grow, adding another layer of complexity to light device control. Consumers are increasingly looking for seamless control of their lighting systems, whether through wall switches, mobile applications, or voice-activated systems. An innovative control solution would need to accommodate these evolving consumer preferences while remaining accessible to a wide range of users.

In addition to consumer needs, energy efficiency plays a crucial role in modern light device design. As LED technology continues to evolve, manufacturers must ensure that control systems maximize the energy-saving potential of these light sources. Traditional wall switches, while effective, may not provide the precision control required to fully optimize LED lighting. An innovative control system would bridge this gap, offering more precise and efficient management of light output.

Adaptability is another key consideration in developing new control systems for light devices. A well-designed solution must be flexible enough to support different lighting configurations, whether for residential, commercial, or industrial applications. This adaptability ensures that manufacturers can offer a universal solution that works across a variety of settings, further reducing costs and simplifying the production process.

Durability and reliability are also paramount in the design of innovative control systems. As lighting systems become more complex, the potential for failures or inconsistencies in control increases. By developing a robust and reliable control system, manufacturers can ensure long-term performance and minimize maintenance needs, which is critical for both consumers and businesses alike.

Finally, the future of light device control lies in the integration of advanced technologies such as artificial intelligence and machine learning. These technologies could be used to create smarter, more intuitive lighting systems that automatically adjust based on user preferences, environmental conditions, and energy consumption patterns. An innovative control system that leverages these advancements would further elevate the user experience while driving significant improvements in energy efficiency.

In conclusion, while wall switch control has served as the backbone of light device design for many years, the evolution of LED technology and the growing demand for more sophisticated control systems present new challenges. By continuing to innovate and develop advanced control solutions, the industry can meet these challenges, ensuring that light device designs remain both functional and cost-effective for years to come.

### SUMMARY

In some embodiments, a lighting apparatus includes an LED driving circuit, an impedance switching circuit and a detection circuit.

The lighting apparatus is coupled to a wall switch for connecting to a main power.

The LED driving circuit is coupled to the wall switch and an LED lamp. The LED driving circuit includes a sampling terminal.

The LED driving circuit is configured to output different driving currents to the LED lamp and perform constant current driving of the LED lamp based on different sampling resistances connected to the sampling terminal.

The impedance switching circuit is coupled to the sampling terminal of the LED driving circuit. The impedance switching circuit is configured to output sampling resistances of different impedances to the sampling terminal of the LED driving circuit in response to different impedance switching signals. The detection circuit is coupled to the wall switch and the impedance switching circuit. The detection circuit is configured to output different impedance switching signals in response to switching actions of the wall switch.

In some embodiments, the LED driving circuit includes a rectification circuit and a constant current driving circuit.

The rectification circuit is coupled to the wall switch.

The rectification circuit is configured to perform rectification conversion on the main power input and output a DC power supply.

The constant current driving circuit is coupled to the rectification circuit, the LED lamp, and the impedance switching circuit.

The constant current driving circuit includes a sampling terminal.

The constant current driving circuit is configured to output different driving currents to the LED lamp and perform constant current driving of the LED lamp based on different sampling resistances connected to the sampling terminal.

In some embodiments, the constant current driving circuit includes any one of a buck circuit, a boost circuit, a buck-boost circuit, and a flyback circuit.

The constant current driving circuit includes a constant current driving chip. The constant current driving chip includes a sampling terminal.

In some embodiments, the rectification circuit includes a rectification bridge.

In some embodiments, the lighting apparatus may also include a power supply circuit.

The power supply circuit is coupled to the rectification circuit and the detection circuit.

The power supply circuit is configured to perform power conversion on the DC power supply output from the rectification circuit and output a working voltage to the detection circuit.

In some embodiments, the power supply circuit includes a first resistor, a capacitor, and a voltage regulating diode.

A first terminal of the first resistor is coupled to an output terminal of the rectification circuit.

A second terminal of the first resistor, a first terminal of the capacitor, a cathode of the voltage regulating diode, and a power terminal of the detection circuit are coupled together.

An anode of the voltage regulating diode and a second terminal of the capacitor are coupled to ground.

In some embodiments, the detection circuit includes a detection chip and a second resistor.

A first terminal of the second resistor forms a signal input terminal of the detection circuit and is coupled to the wall switch.

A second terminal of the second resistor is coupled to a signal input terminal of the detection chip.

At least one signal output terminal of the detection chip is coupled to a control terminal of the impedance switching circuit.

In some embodiments, the impedance switching circuit includes a plurality of parallel impedance branches.

Each impedance branch of the plurality of parallel impedance branches includes a sampling resistor and a switching switch connected in series.

A control terminal of the switching switch is coupled to a signal output terminal of the detection circuit.

In some embodiments, the impedance switching circuit includes a digital potentiometer.

In some embodiments, the LED lamp includes a light strip.

The light strip includes multiple LED modules with different parameters.

The driver circuit converts an operation of the wall switch to an instruction to generate driving signals to the LED modules to mix a required light parameter.

In some embodiments, the lighting apparatus may also include a light signal detector.

The driver circuit disables light of the LED lamp while activates the light signal detector to receives a first light modulated signal.

In some embodiments, the driver circuit decodes the light modulation signal to extract a control command.

In some embodiments, the wall switch is operated with a predetermined pattern to activate the receipt of the light modulated signal.

In some embodiments, the driver circuit controls the LED lamp to send a second light modulated signal encoded in the light of the LED lamp to a remote device.

In some embodiments, the remote control device decodes the second light modulated signal to acquire a model parameter of the lighting apparatus.

In some embodiments, the remote control adjusts a command sent to the driver circuit based on the model parameter.

In some embodiments, the driver circuit adjusts a setting for responding the wall switch based on the first light modulated signal.

In some embodiments, the wall switch is also connected to a second lighting apparatus.

The driver circuit uses a light detector to clone a behavior of the second lighting apparatus responding to an operation pattern of the wall switch.

In some embodiments, the light detector detects a output light parameter of the second lighting apparatus and the driver circuit controls the LED lamp to emit consistent light parameter.

In some embodiments, the driver circuit issues a visible signal by the LED lamp to feedback to a user when the user operates the wall switch.

### BRIEF DESCRIPTION OF DRAWINGS

FIG. 1 illustrates a circuit diagram

FIG. 2 illustrates a mother detail circuit diagram.

FIG. 3 illustrates another circuit diagram based on an embodiment.

FIG. 4 illustrates a detailed circuit design example.

FIG. 5 illustrates another lighting apparatus embodiment.

FIG. 6 illustrates another lighting apparatus embodiment.

### DETAILED DESCRIPTION

In this embodiment, a first aspect proposes a lighting apparatus 100, which includes a wall switch 10 connected to main power AC. The wall switch 10 switches to different switching actions in response to user trigger actions and controls the on-off state of the main power AC, for example, by switching on and off n times within a unit time, and achieves multi-level brightness adjustment of the LED lamp 200 through the lighting apparatus 100.

To simplify the circuit structure of the lighting apparatus 100, it further includes: an LED driving circuit 20, connected to the wall switch 10 and LED lamp 200, with a sampling terminal VS. The LED driving circuit 20 outputs different driving currents to the LED lamp 200 when triggered by different sampling resistances RS connected to the sampling terminal VS, and provides constant current drive to illuminate the LED lamp 200.

An impedance switching circuit 30 is connected to the sampling terminal VS of the LED driving circuit 20. The impedance switching circuit 30 outputs different sampling resistances RS to the sampling terminal VS of the LED driving circuit 20 when triggered by different impedance switching signals. A detection circuit 40 is connected to the wall switch 10 and impedance switching circuit 30. The detection circuit 40 outputs different impedance switching signals when triggered by switching actions of the wall switch 10.

In this embodiment, the LED driving circuit 20 performs power conversion work. When the wall switch 10 is in the on state, it converts the input main power AC to DC power output to the LED lamp 200. Additionally, it outputs matching driving current based on the resistance value at the sampling terminal VS and achieves constant current drive to maintain the LED lamp 200 at a preset brightness.

The driving current of the LED driving circuit 20 has a corresponding matching relationship with the sampling resistance RS at the sampling terminal VS. When the sampling resistance RS changes, the output driving current changes, which can be linear or non-linear change, depending on specific requirements.

When the lighting apparatus 100 is working, the detection circuit 40 detects the switching actions of the wall switch 10, specifically detecting the number of switches and switching delay time of the wall switch 10. Based on the detected switching actions combined with internal clock information, it outputs matching impedance switching signals. After the impedance switching signals are output to the impedance switching circuit 30, the impedance switching circuit 30 switches to output matching sampling resistance RS to the sampling terminal VS of the LED driving circuit 20. The LED driving circuit 20 outputs matching driving current based on the resistance value at the sampling terminal VS and achieves constant current drive to maintain the LED lamp 200 at a preset brightness.

For example, when the wall switch 10 performs one off-to-on switch within a unit time, the LED driving circuit 20 powers on. Meanwhile, the detection circuit 40 outputs the first impedance switching signal, and the impedance switching circuit 30 switches to output the first sampling resistance to the sampling terminal VS of the LED driving circuit 20. The LED driving circuit 20 outputs the first driving current to the LED lamp 200 with constant current based on the first sampling resistance, and the LED lamp 200 illuminates at the first brightness level under the drive of the first driving current.

Alternatively, when the wall switch 10 performs two off-to-on switching operations within a unit time, the LED driving circuit 20 powers on. Meanwhile, after detecting the action of the wall switch 10, the detection circuit 40 triggers and outputs the second impedance switching signal to the impedance switching circuit 30. The impedance switching circuit 30 switches to output the second sampling resistance to the sampling terminal VS of the LED driving circuit 20. The LED driving circuit 20 outputs the second driving current to the LED lamp 200 with constant current based on the second sampling resistance, and the LED lamp 200 illuminates at the second brightness level under the drive of the second driving current.

Alternatively, when the wall switch 10 performs three off-to-on switching operations within a unit time, the LED driving circuit 20 powers on. Meanwhile, after detecting the action of the wall switch 10, the detection circuit 40 triggers and outputs the third impedance switching signal to the impedance switching circuit 30. The impedance switching circuit 30 switches to output the third sampling resistance to the sampling terminal VS of the LED driving circuit 20. The LED driving circuit 20 outputs the third driving current to the LED lamp 200 with constant current based on the third sampling resistance, and the LED lamp 200 illuminates at the third brightness level under the drive of the third driving current.

And so on, the detection circuit 40 outputs different impedance switching signals based on different switching actions of the wall switch 10, thereby triggering the impedance switching circuit 30 to switch and output different sampling resistances RS to the LED driving circuit 20, thus driving the LED driving circuit 20 to output different constant current driving currents to the LED lamp 200, achieving three-level or multi-level dimming control. The first brightness, second brightness, and third brightness can gradually increase or decrease, with no limitation on the specific pattern of change.

This embodiment eliminates the need for complex MCU control circuits, achieving current adjustment in the lighting apparatus 100 by switching the sampling resistance RS of the impedance switching circuit 30 in a preset sequence. With fewer components and simpler circuitry, it can be widely applied to miniaturized lighting fixtures and automated production.

The driven LED lamp 200 can be either a single LED lamp 200 or a string of lamps, with no specific restrictions on the LED lamp 200 structure.

The wall switch 10 can be configured according to corresponding trigger forms, including touch switches, push-button switches, knob switches, remote control switches, etc., with no specific structural limitations.

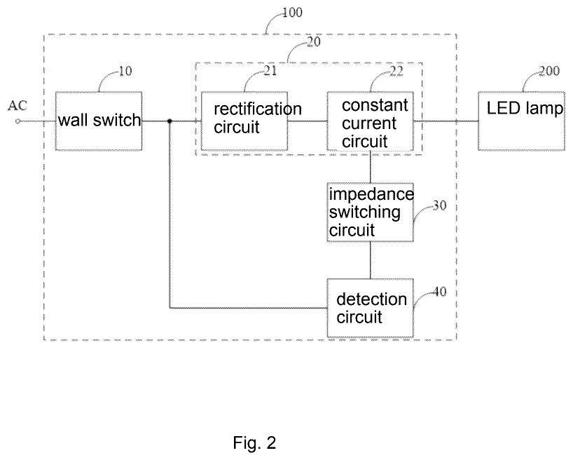

The LED driving circuit 20 can be configured with corresponding rectification circuit 21, power conversion circuit, and filter circuit according to its operating mode. As shown in FIG. 2, in one possible embodiment, the LED driving circuit 20 includes: A rectification circuit 21, connected to the wall switch 10, configured to rectify the input main power AC and output DC power; A constant current driving circuit 22, connected to the rectification circuit 21, LED lamp 200, and impedance switching circuit 30, having a sampling terminal VS. The constant current driving circuit 22 outputs different driving currents to the LED lamp 200 when triggered by different sampling resistances connected to the sampling terminal VS, and maintains constant current to drive the LED lamp 200 illumination.

In this embodiment, when the wall switch 10 is conducting, main power AC outputs to the rectification circuit 21, which converts the main power AC to DC power. The constant current driving circuit 22 converts the DC power to a working voltage matching the LED lamp 200, and can perform buck, boost, or voltage stabilization conversions.

Meanwhile, the constant current driving circuit 22 has a sampling terminal VS connected to the impedance switching circuit 30. When the lighting apparatus 100 is operating, the detection circuit 40 monitors the wall switch 10's switching actions, specifically the number of switches and switch delay time. Based on the detected switching actions and internal clock information, it outputs matching impedance switching signals. After these signals are output to the impedance switching circuit 30, it switches to output matching sampling resistance RS to the sampling terminal VS of the constant current driving circuit 22. The constant current driving circuit 22 outputs matching driving current based on the resistance value at the sampling terminal VS and achieves constant current driving, maintaining the LED lamp 200 at preset brightness.

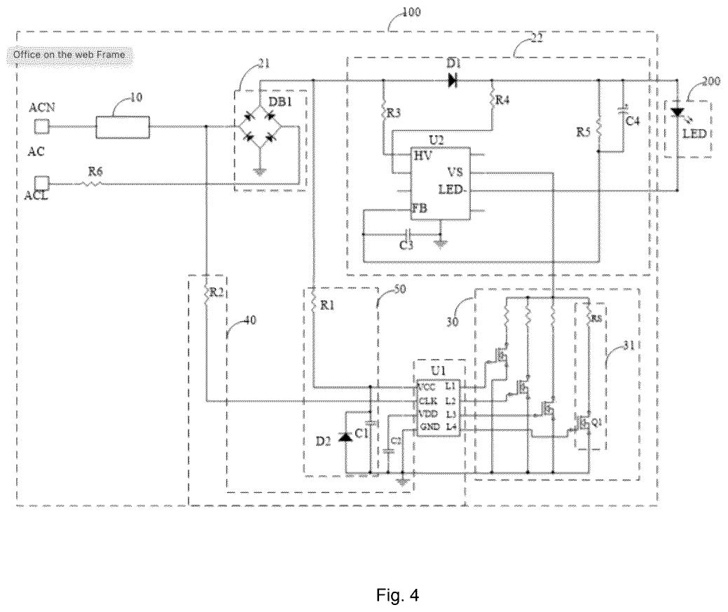

The rectification circuit 21 can use full-bridge or half-bridge rectification circuits. In one possible embodiment, as shown in FIG. 4, the rectification circuit 21 includes a rectification bridge DB1.

According to the power conversion method, the constant current driving circuit 22 selects the corresponding power conversion circuit. In one possible embodiment, the constant current driving circuit 22 includes any one of buck circuit, boost circuit, buck-boost circuit, and flyback circuit; The constant current driving circuit 22 includes a constant current driving chip U2, which has a sampling terminal VS.

When the lighting apparatus 100 is operating, the detection circuit 40 monitors the wall switch 10's switching actions, specifically the number of switches and switch delay time. Based on the detected switching actions and internal clock information, it outputs matching impedance switching signals. After these signals are output to the impedance switching circuit 30, it switches to output matching sampling resistance RS to the sampling terminal VS of the constant current driving chip U2. The constant current driving chip U2 outputs matching driving current to the LED lamp 200 based on the resistance value at the sampling terminal VS and achieves constant current driving, maintaining the LED lamp 200 at preset brightness.

In one possible embodiment, as shown in FIG. 4, the constant current driving circuit 22 also includes third resistor R3, fourth resistor R4, fifth resistor R5, and fourth capacitor C4. The constant current driving chip U2 obtains working power through the third resistor R3, and detects output voltage and current through the fourth resistor R4 and fifth resistor R5, adjusting feedback based on the detected voltage and current signals to achieve constant current output.

Meanwhile, the constant current driving chip U2's sampling terminal VS is connected to the impedance switching circuit 30. The constant current driving chip U2 outputs matching driving current to the LED lamp 200 based on the resistance value at the sampling terminal VS and achieves constant current driving, maintaining the LED lamp 200 at preset brightness.

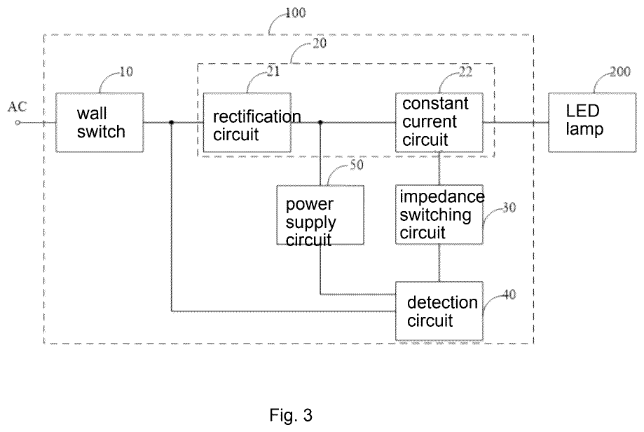

The detection circuit 40 can have its own power supply, or be powered by the rectification circuit 21. As shown in FIG. 3, in one optional embodiment, the lighting apparatus 100 also includes: A power supply circuit 50, connected to the rectification circuit 21 and detection circuit 40. The power supply circuit 50 is configured to convert the DC power output from the rectification circuit 21 and output working voltage to the detection circuit 40.

The power supply circuit 50 implements power conversion to ensure the working voltage output to the detection circuit 40 meets its operating range. The power supply circuit 50 can adopt corresponding power conversion circuits, with no specific structural limitations.

To further simplify the structure and design cost of the lighting apparatus 100, in one optional embodiment, the power supply circuit 50 includes a first resistor R1, capacitor C1, and voltage regulating diode D2; The first terminal of first resistor R1 connects to the output terminal of rectification circuit 21, while the second terminal of first resistor R1, first terminal of capacitor C1, cathode of voltage regulating diode D2, and power terminal VCC of detection circuit 40 are connected together. The anode of voltage regulating diode D2 and the second terminal of capacitor C1 are both connected to ground.

In this arrangement, first resistor R1 implements voltage reduction to ensure the working voltage output to detection circuit 40 meets its operating range. The voltage regulating diode D2 stabilizes the input voltage of detection circuit 40 to prevent false triggering from voltage fluctuations. The capacitor C1 performs filtering to remove interference that could affect detection circuit 40 operation.

The detection circuit 40 can utilize corresponding detection chip U1, triggers, decoders, or other structures. In one optional embodiment, as shown in FIG. 4, the detection circuit 40 includes detection chip U1 and second resistor R2; The first terminal of second resistor R2 forms the signal input terminal of detection circuit 40 and connects to wall switch 10, while its second terminal connects to the signal input terminal CLK of detection chip U1. At least one signal output terminal of detection chip U1 connects to the control terminal of impedance switching circuit 30.

In this embodiment, second resistor R2 implements voltage reduction to prevent high AC voltage from damaging detection chip U1. Detection chip U1 monitors the switching actions of wall switch 10, specifically detecting the number of switches and switching delay time. Based on the detected switching actions and internal clock information, it outputs matching impedance switching signals. When these signals are output to impedance switching circuit 30, it switches to output matching sampling resistance RS to the sampling terminal VS of LED driving circuit 20. The LED driving circuit 20 outputs matching driving current based on the resistance value at sampling terminal VS and implements constant current driving, maintaining the LED lamp 200 at preset brightness.

The impedance switching circuit 30 can utilize corresponding resistor arrays and switching circuits, or potentiometers, sliding rheostats, etc. In one optional embodiment, as shown in FIG. 4, impedance switching circuit 30 includes multiple parallel impedance branches 31; Each impedance branch 31 includes a series connection of sampling resistance RS and switching switch Q1, with the control terminal of switching switch Q1 connected to the signal output terminal of detection circuit 40.

In this embodiment, the resistance values of each sampling resistance RS can be equal or unequal. During each dimming operation, the impedance switching circuit 30 can trigger one or multiple switching switches Q1 to conduct. When only one switching switch Q1 is triggered to conduct during each dimming operation, the resistance values of each sampling resistance RS are unequal, thereby outputting sampling resistances RS with different resistance values to the sampling terminal VS of the LED driving circuit 20 under different switching modes.

When multiple switches are triggered to conduct during each dimming operation, multiple sampling resistances RS are connected in parallel to form an equivalent sampling resistance RS with a corresponding resistance value. In this case, the resistance values of each sampling resistance RS can be equal or unequal, thereby outputting parallel-connected sampling resistances RS with different resistance values to the sampling terminal VS of the LED driving circuit 20 under different switching modes.

The switching switch Q1 can use controllable switching devices, such as MOS transistors, transistors, or relays. In one optional embodiment, the switching switch Q1 is an NMOS transistor. The NMOS transistor is connected in parallel with the sampling resistance RS between the sampling terminal VS of the LED driving circuit 20 and ground. The gate of the NMOS transistor is connected to the signal terminal of the detection circuit 40, and it turns on or off according to the high or low level impedance switching signals output by the detection circuit 40, thereby switching and outputting sampling resistances RS of corresponding values to the sampling terminal VS of the LED driving circuit 20.

The impedance branch 31 includes at least two branches, enabling the switching and output of at least three different resistance values of sampling resistance.

In another optional embodiment, the impedance switching circuit 30 includes a digital potentiometer, which switches and outputs different sampling resistances RS to the sampling terminal VS of the LED driving circuit 20 according to the digital control signals output by the detection circuit 40.

Compared with existing technology, this embodiment has the following advantages: The lighting apparatus 100 consists of a wall switch 10, LED driving circuit 20, impedance switching circuit 30, and detection circuit 40. The detection circuit 40 detects switching actions of the wall switch 10 to trigger and output impedance switching signals, which trigger the impedance switching circuit 30 to switch and output different sampling resistances RS to the LED driving circuit 20. The LED driving circuit 20 outputs corresponding constant drive current to the LED lamp 200. The circuit structure is simple, uses fewer components, has low cost, and can be widely applied to small-scale lighting fixtures and automated production.

This utility model also proposes a lighting fixture that includes an LED lamp 200 and a lighting apparatus 100. The specific structure of this lighting apparatus 100 refers to the above embodiment. Since this lighting fixture adopts all technical solutions of the above embodiments, it therefore has all the beneficial effects brought by the technical solutions of the above embodiments, which will not be repeated here.

The LED lamp 200 can be a single LED lamp 200 or a string of lights, and the specific structure of the LED lamp 200 is not limited.

The lighting apparatus 100 includes a wall switch 10, which is used to connect to main power AC. The wall switch 10 responds to user trigger actions by switching to different switching states and controls the main power AC accordingly, such as switching n times quickly within a unit time, and performs multi-level brightness adjustment of the LED lamp 200 through the detection circuit 40, impedance switching circuit 30, and LED driving circuit 20 in the lighting apparatus 100.

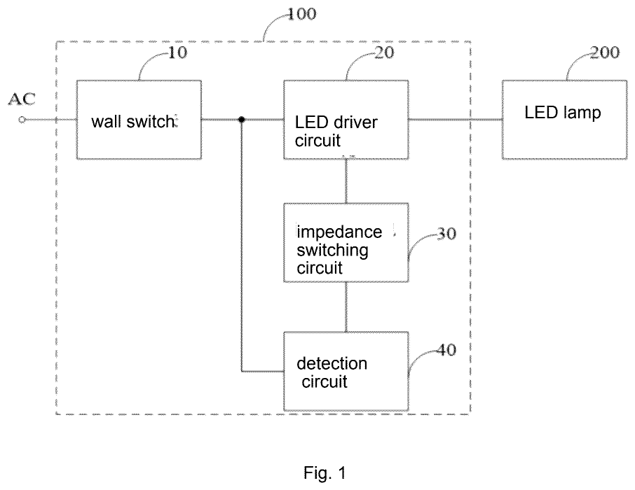

The following describes the working principle of the above lighting apparatus 100 and lighting fixture in conjunction with FIG. 1 to FIG. 4:

First, the wall switch 10 connects to main power AC, and the rectification bridge DB1 converts the main power AC to DC power. The power supply circuit 50 converts the DC power and outputs matching working voltage to the detection circuit 40. The detection chip U1 in the detection circuit 40 detects the switching actions of the wall switch 10 and outputs matching impedance switching signals to one or multiple corresponding switching switches Q1 in the impedance switching circuit 30. Several of the multiple switching switches Q1 conduct and switch to output matching sampling resistance RS to the sampling terminal VS of the constant current driving chip U2. The constant current driving chip U2 converts and outputs matching drive current and provides constant current drive to the LED lamp 200, causing the LED lamp 200 to illuminate at matching brightness according to the current drive current.

Existing lighting fixtures typically use opening or closing of the wall switch to control the illumination, extinction, and multi-level dimming of the light source.

Currently, most wall-controlled three-level or multi-level dimming circuits are based on MCU control methods, which achieve switch detection and dimming output through firmware logic operations within the MCU, resulting in complex circuit structure and high cost.

Compared with existing technology, this embodiment has the following advantages: The lighting apparatus consists of a wall switch, LED driving circuit, impedance switching circuit, and detection circuit. The detection circuit detects switching actions of the wall switch to trigger and output impedance switching signals, which trigger the impedance switching circuit to switch and output different sampling resistances to the LED driving circuit. The LED driving circuit outputs corresponding constant drive current to the LED lamp. The circuit structure is simple, uses fewer components, has low cost, and can be widely applied to small-scale lighting fixtures and automated production.

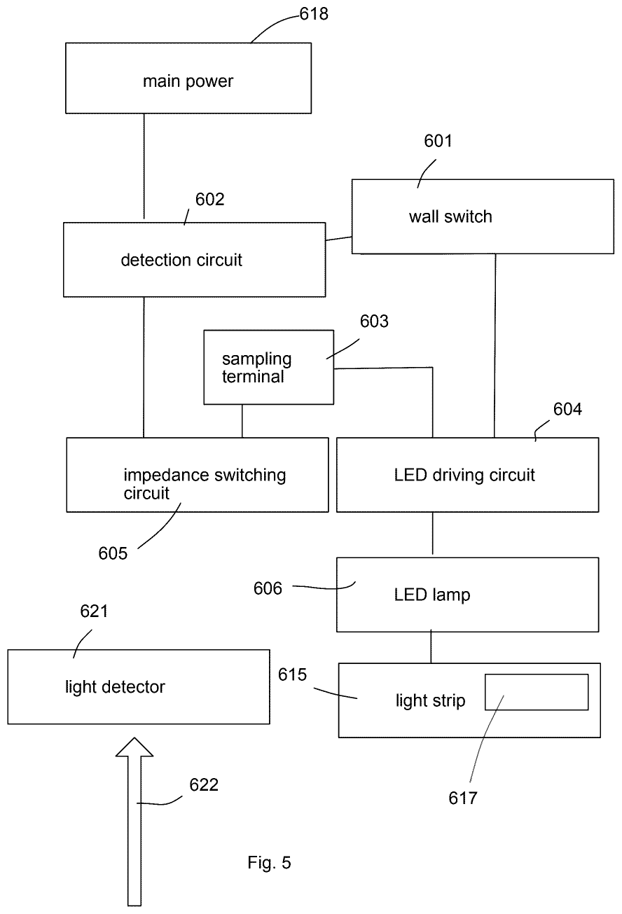

In FIG. 5, a lighting apparatus includes an LED driving circuit 604, an impedance switching circuit 605 and a detection circuit 602.

The lighting apparatus is coupled to a wall switch 602 for connecting to a main power 618, which may be a 110V AC power source.

The LED driving circuit 604 is coupled to the wall switch 602 and an LED lamp 606. The LED driving circuit 604 includes a sampling terminal 603.

The LED driving circuit is configured to output different driving currents to the LED lamp and perform constant current driving of the LED lamp based on different sampling resistances connected to the sampling terminal. More detail examples are provided above.

The impedance switching circuit is coupled to the sampling terminal of the LED driving circuit. The impedance switching circuit is configured to output sampling resistances of different impedances to the sampling terminal of the LED driving circuit in response to different impedance switching signals. The detection circuit is coupled to the wall switch and the impedance switching circuit. The detection circuit is configured to output different impedance switching signals in response to switching actions of the wall switch.

In some embodiments, the LED driving circuit includes a rectification circuit and a constant current driving circuit.

The rectification circuit is coupled to the wall switch.

The rectification circuit is configured to perform rectification conversion on the main power input and output a DC power supply.

The constant current driving circuit is coupled to the rectification circuit, the LED lamp, and the impedance switching circuit.

The constant current driving circuit includes a sampling terminal.

The constant current driving circuit is configured to output different driving currents to the LED lamp and perform constant current driving of the LED lamp based on different sampling resistances connected to the sampling terminal.

In some embodiments, the constant current driving circuit includes any one of a buck circuit, a boost circuit, a buck-boost circuit, and a flyback circuit.

The constant current driving circuit includes a constant current driving chip. The constant current driving chip includes a sampling terminal.

In some embodiments, the rectification circuit includes a rectification bridge.

In some embodiments, the lighting apparatus may also include a power supply circuit.

The power supply circuit is coupled to the rectification circuit and the detection circuit.

The power supply circuit is configured to perform power conversion on the DC power supply output from the rectification circuit and output a working voltage to the detection circuit.

In some embodiments, the power supply circuit includes a first resistor, a capacitor, and a voltage regulating diode.

A first terminal of the first resistor is coupled to an output terminal of the rectification circuit.

A second terminal of the first resistor, a first terminal of the capacitor, a cathode of the voltage regulating diode, and a power terminal of the detection circuit are coupled together.

An anode of the voltage regulating diode and a second terminal of the capacitor are coupled to ground.

In some embodiments, the detection circuit includes a detection chip and a second resistor.

A first terminal of the second resistor forms a signal input terminal of the detection circuit and is coupled to the wall switch.

A second terminal of the second resistor is coupled to a signal input terminal of the detection chip.

At least one signal output terminal of the detection chip is coupled to a control terminal of the impedance switching circuit.

In some embodiments, the impedance switching circuit includes a plurality of parallel impedance branches.

Each impedance branch of the plurality of parallel impedance branches includes a sampling resistor and a switching switch connected in series.

A control terminal of the switching switch is coupled to a signal output terminal of the detection circuit.

In some embodiments, the impedance switching circuit includes a digital potentiometer.

In FIG. 5, the LED lamp includes a light strip 615. These components mentioned above may be integrated as a light strip bulb that has compact design.

The light strip includes multiple LED modules 617 with different parameters.

The driver circuit converts an operation of the wall switch to an instruction to generate driving signals to the LED modules to mix a required light parameter.

In some embodiments, the lighting apparatus may also include a light signal detector 621.

Using light to carry signals involves manipulating the properties of light to encode information, which can then be transmitted and decoded by a receiver. One common approach to this is modulating the intensity, or strength, of the light over time. By varying the brightness in a specific pattern, data can be represented as a series of changes in light intensity. This modulation can be done in rapid succession, allowing light to act as a carrier for the signal over long distances or through complex networks.

The modulation of light signals can be achieved through pulse width modulation (PWM). In this method, the duration of each pulse of light represents different pieces of information. For instance, a longer pulse might signify a binary “1,” while a shorter pulse represents a binary “0.” By alternating the width of these light pulses at high speeds, a continuous stream of data can be encoded and transmitted. Since light can travel at extremely high speeds, this technique allows for efficient, fast data transmission across various mediums, such as fiber optics or free-space communication.

Once the modulated light reaches its destination, it must be decoded to retrieve the original information. This can be accomplished by using a light-sensitive receiver, such as a photodetector, which converts light back into electrical signals. The variations in light intensity are interpreted by the receiver and transformed into corresponding electrical pulses. These pulses are then analyzed based on the pattern of intensity changes, and the information they represent can be extracted and processed further.

In addition to intensity modulation, other techniques such as frequency modulation can be employed to carry signals with light. This involves changing the frequency of the light waves to represent different data points. By switching between different frequencies of light in a controlled manner, complex signals can be encoded without relying solely on variations in light strength. This method can offer increased bandwidth and is often used in more advanced optical communication systems.

After the receiver captures the modulated light and converts it back into an electrical signal, the data undergoes a decoding process. This typically involves software or hardware that analyzes the timing, intensity, or frequency variations in the signal and reconstructs the original data. The ability to accurately interpret these changes is critical to maintaining the integrity of the transmitted information, ensuring that the message is delivered in its correct form.

The driver circuit disables light of the LED lamp while activates the light signal detector 6231 to receives a first light modulated signal 622.

In some embodiment, a technique can be used to improve signal quality involves temporarily turning off the light source at specific intervals. This brief interruption in the light emission can help reduce interference and noise, which are common challenges in optical signal transmission. By controlling the light in such a way, the system can better manage how signals are encoded and decoded, leading to a more accurate transmission of data. While this turning off of the light may seem counterproductive at first, it actually plays a crucial role in improving the overall communication process.

The periods during which the light source is turned off are designed to be extremely brief-so short that they are virtually undetectable by the human eye. This is because the on-off cycling happens at a frequency much higher than what humans can perceive. As a result, even though the light source is temporarily switched off, the visible light appears to be steady and continuous to anyone observing it. This non-disruptive nature of the process allows communication to continue seamlessly without affecting the user experience.

One of the key advantages of this approach is that it reduces the influence of noise and other external factors on the signal. When the light is briefly turned off, it gives the system a moment to reset and minimize the accumulation of signal distortions. These distortions could arise from interference, reflections, or environmental light sources. By implementing these temporary pauses, the light communication system can deliver a clearer, higher-quality signal, ultimately improving data transmission accuracy and reducing errors.

In addition to enhancing signal quality, this brief turn-off time also helps in maintaining the integrity of the communication channel, especially in environments with multiple light sources. When different light sources are present, their overlapping signals can create interference. By incorporating temporary turn-offs, the communication system can better differentiate between the signals, improving overall performance. Although undetectable by humans, these brief interruptions are a valuable tool for ensuring efficient and reliable optical communication.

In some embodiments, the driver circuit decodes the light modulation signal to extract a control command.

In some embodiments, the wall switch is operated with a predetermined pattern to activate the receipt of the light modulated signal.

In some embodiments, the driver circuit controls the LED lamp to send a second light modulated signal encoded in the light of the LED lamp to a remote device.

In some embodiments, the remote control device decodes the second light modulated signal to acquire a model parameter of the lighting apparatus.

In some embodiments, the remote control adjusts a command sent to the driver circuit based on the model parameter.

In some embodiments, the driver circuit adjusts a setting for responding the wall switch based on the first light modulated signal.

In some embodiments, the wall switch is also connected to a second lighting apparatus.

The driver circuit uses a light detector to clone a behavior of the second lighting apparatus responding to an operation pattern of the wall switch.

In some embodiments, the light detector detects a output light parameter of the second lighting apparatus and the driver circuit controls the LED lamp to emit consistent light parameter.

In some embodiments, the driver circuit issues a visible signal by the LED lamp to feedback to a user when the user operates the wall switch.

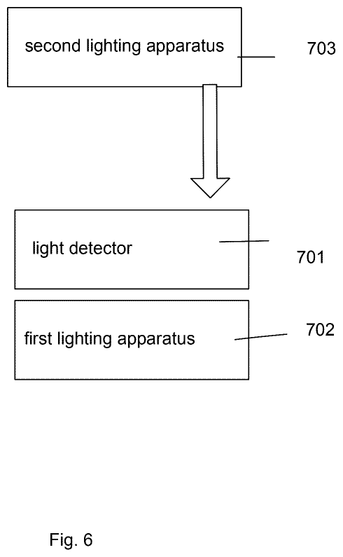

FIG. 6 shows that the first lighting apparatus 702 and the second lighting apparatus 703 are both controlled by a wall switch. The first lighting apparatus 702 has a light detector to clone the behavior of the second light lighting apparatus on how the second lighting apparatus 703 respond to operations of the wall switch. This makes the controlling easier. In addition, the first lighting apparatus 702 may also detect output light of the second lighting apparatus to make them consistent.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings.

The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

1. A lighting apparatus, coupled to a wall switch for connecting to a main power, comprising:
an LED driving circuit, wherein the LED driving circuit is coupled to the wall switch and an LED lamp, wherein the LED driving circuit comprises a sampling terminal, wherein the LED driving circuit is configured to output different driving currents to the LED lamp and perform constant current driving of the LED lamp based on different sampling resistances connected to the sampling terminal;
an impedance switching circuit, wherein the impedance switching circuit is coupled to the sampling terminal of the LED driving circuit, wherein the impedance switching circuit is configured to output sampling resistances of different impedances to the sampling terminal of the LED driving circuit in response to different impedance switching signals; and
a detection circuit, wherein the detection circuit is coupled to the wall switch and the impedance switching circuit, wherein the detection circuit is configured to output different impedance switching signals in response to switching actions of the wall switch.

2. The lighting apparatus of claim 1, wherein the LED driving circuit comprises a rectification circuit and a constant current driving circuit, wherein the rectification circuit is coupled to the wall switch, wherein the rectification circuit is configured to perform rectification conversion on the main power input and output a DC power supply, wherein the constant current driving circuit is coupled to the rectification circuit, the LED lamp, and the impedance switching circuit, wherein the constant current driving circuit comprises a sampling terminal, wherein the constant current driving circuit is configured to output different driving currents to the LED lamp and perform constant current driving of the LED lamp based on different sampling resistances connected to the sampling terminal.

3. The lighting apparatus of claim 2, wherein the constant current driving circuit comprises any one of a buck circuit, a boost circuit, a buck-boost circuit, and a flyback circuit, wherein the constant current driving circuit comprises a constant current driving chip, wherein the constant current driving chip comprises a sampling terminal.

4. The lighting apparatus of claim 2, wherein the rectification circuit comprises a rectification bridge.

5. The lighting apparatus of claim 2, further comprising a power supply circuit, wherein the power supply circuit is coupled to the rectification circuit and the detection circuit, wherein the power supply circuit is configured to perform power conversion on the DC power supply output from the rectification circuit and output a working voltage to the detection circuit.

6. The lighting apparatus of claim 5, wherein the power supply circuit comprises a first resistor, a capacitor, and a voltage regulating diode, wherein a first terminal of the first resistor is coupled to an output terminal of the rectification circuit, wherein a second terminal of the first resistor, a first terminal of the capacitor, a cathode of the voltage regulating diode, and a power terminal of the detection circuit are coupled together, wherein an anode of the voltage regulating diode and a second terminal of the capacitor are coupled to ground.

7. The lighting apparatus of claim 1, wherein the detection circuit comprises a detection chip and a second resistor, wherein a first terminal of the second resistor forms a signal input terminal of the detection circuit and is coupled to the wall switch, wherein a second terminal of the second resistor is coupled to a signal input terminal of the detection chip, wherein at least one signal output terminal of the detection chip is coupled to a control terminal of the impedance switching circuit.

8. The lighting apparatus of claim 1, wherein the impedance switching circuit comprises a plurality of parallel impedance branches, wherein each impedance branch of the plurality of parallel impedance branches comprises a sampling resistor and a switching switch connected in series, wherein a control terminal of the switching switch is coupled to a signal output terminal of the detection circuit.

9. The lighting apparatus of claim 1, wherein the impedance switching circuit comprises a digital potentiometer.

10. The lighting apparatus of claim 1, wherein the LED lamp comprises a light strip, wherein the light strip comprises multiple LED modules with different parameters, wherein the driver circuit converts an operation of the wall switch to an instruction to generate driving signals to the LED modules to mix a required light parameter.

11. The lighting apparatus of claim 1, further comprising a light signal detector, wherein the driver circuit disables light of the LED lamp while activates the light signal detector to receives a first light modulated signal.

12. The lighting apparatus of claim 11, wherein the driver circuit decodes the light modulation signal to extract a control command.

13. The lighting apparatus of claim 11, wherein the wall switch is operated with a predetermined pattern to activate the receipt of the light modulated signal.

14. The lighting apparatus of claim 11, wherein the driver circuit controls the LED lamp to send a second light modulated signal encoded in the light of the LED lamp to a remote device.

15. The lighting apparatus of claim 14, wherein the remote control device decodes the second light modulated signal to acquire a model parameter of the lighting apparatus.

16. The lighting apparatus of claim 15, wherein the remote control adjusts a command sent to the driver circuit based on the model parameter.

17. The lighting apparatus of claim 11, wherein the driver circuit adjusts a setting for responding the wall switch based on the first light modulated signal.

18. The lighting apparatus of claim 11, wherein the wall switch is also connected to a second lighting apparatus, wherein the driver circuit uses a light detector to clone a behavior of the second lighting apparatus responding to an operation pattern of the wall switch.

19. The lighting apparatus of claim 18, wherein the light detector detects a output light parameter of the second lighting apparatus and the driver circuit controls the LED lamp to emit consistent light parameter.

20. The lighting apparatus of claim 11, wherein the driver circuit issues a visible signal by the LED lamp to feedback to a user when the user operates the wall switch.
